(19) United States
(12) Patent Application Publication
(10) Pub. No.: US 2021/0114488 A1
(43) Pub. Date: Apr. 22, 2021

(54) MOUNTING A SEAT IN A VEHICLE

(71) Applicant: International Truck Intellectual Property Company, LLC, Lisle, IL (US)

(72) Inventors: PETER WONG, Naperville, IL (US); ADITYA RAJDERKAR, Hoffman Estates, IL (US); HECTOR KIELY, Plainfield, IL (US)

(73) Assignee: International Truck Intellectual Property Company, LLC, Lisle, IL (US)

(21) Appl. No.: 16/839,310

(22) Filed: Apr. 3, 2020

Related U.S. Application Data
(60) Provisional application No. 62/923,834, filed on Oct. 21, 2019.

(51) Int. Cl. B60N 2/07; B60N 2/015

(52) U.S. Cl. CPC B60N 2/0732; B60N 2/075; B60N 2/015

(57) ABSTRACT

An apparatus for mounting a seat in a vehicle having a floor and a side wall comprises a track having a groove disposed on the floor. A stud including a base and a shank, the base being configured to be inserted into the groove, is disposed within the groove. A flange having a lip is disposed on the side wall. At least one lip aperture is formed on the lip. A support, including a base, is disposed on one end of the seat. A base aperture is disposed on the base. A lip fastener is accepted by the at least one lip aperture to connect an end of the seat opposite to the base to the lip on the flange. The base aperture accepts the shank included on the stud.

### REFERENCE TO RELATED APPLICATIONS

This application is related to and claims priority from U.S. provisional patent application No. 62/923,834 filed on Oct. 29, 2019.

### BACKGROUND

### Background

This disclosure generally relates to mounting a seat in a vehicle. More specifically, this disclosure relates to apparatus and a method for mounting a passenger seat in a school bus.

in some currently available vehicles, such as a school bus and the like, a passenger seat is mounted to or on a floor of the vehicle using hardware, such as a combination of a bolt, a washer, a nut and/or a reinforcement plate and the like. Because this hardware often extends through the floor of the vehicle, use of this hardware may require access from both inside the vehicle and under the vehicle to mount a seat in the vehicle. Using this hardware to mount a seat in a vehicle can increase time and labor associated with constructing a vehicle. Accordingly, it is desirable to provide an improved apparatus and a method for mounting a seat in a vehicle.

### SUMMARY

This disclosure describes apparatus and methods for mounting a seat in a vehicle. One embodiment provides an apparatus for mounting a seat in a vehicle having a floor and a side wall. A track having a groove is disposed on the floor. A stud including a base and a shank, the base being configured to be inserted into the groove, is disposed within the groove. A flange having a lip is disposed on the side wall. At least one lip aperture is formed on the lip. A support, including a base, is disposed on one end of the seat. A base aperture is disposed on the base. A lip fastener is accepted by the at least one lip aperture to connect an end of the seat opposite to the base to the lip on the flange. The base aperture accepts the shank included on the stud.

### DESCRIPTION OF THE DRAWINGS

FIG. 1 is a perspective view of an apparatus described herein for mounting a seat in a vehicle;

FIG. 2 is a sectional view of a portion of the apparatus of FIG. 1;

FIG. 3 is another sectional view of the portion of the apparatus of FIG. 1;

FIG. 4 is a perspective view of a portion of the apparatus of FIG. 1 showing a portion of a method of mourning a seat in a vehicle discussed herein;

FIG. 4A is a perspective view of a portion of the apparatus of FIG. 4;

FIG. 5 is perspective view of another portion of the apparatus of FIG. 1;

FIGS. 5A is a magnified view of a portion contained within a circle in FIG. 5; and

FIG. 6 is a perspective view of a seat mounted in a vehicle using the apparatus of

### DETAILED DESCRIPTION

This disclosure relates generally to mounting a seat in a vehicle. More specifically, this disclosure relates to apparatus and a method for mounting a passenger seat in a school bus. These apparatus and method comply with 49 CFR § 571.207, 49 CFR § 571.210 and 49 CFR § 571.222.

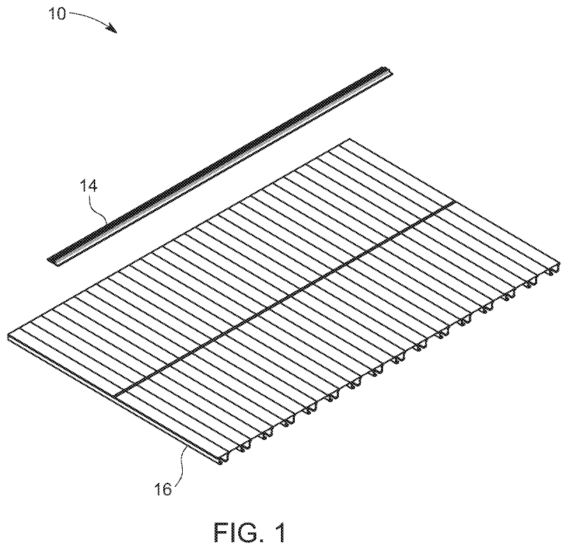

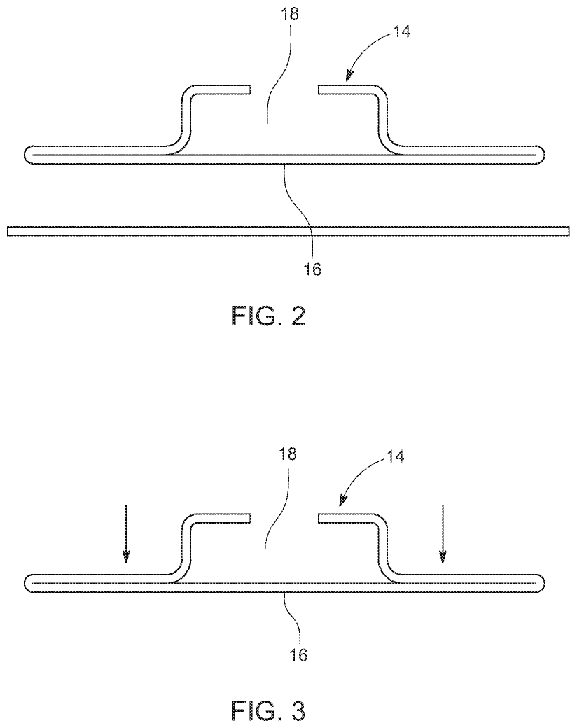

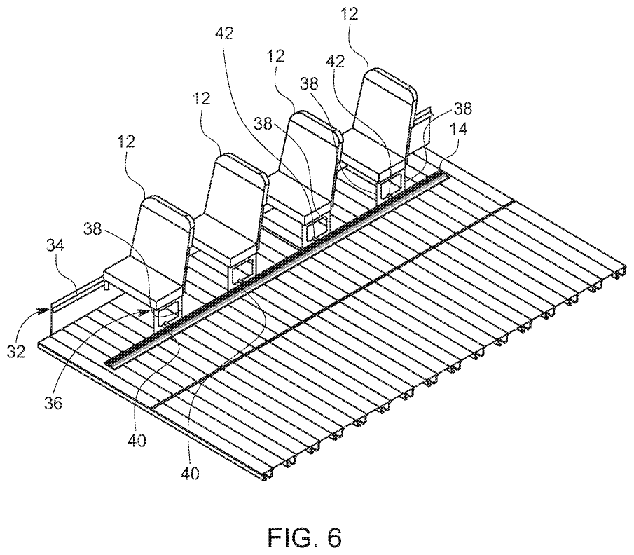

As shown in FIG. 1, one embodiment of an apparatus 10 for mounting a seat 12, as shown in FIG. 6, in a vehicle. This apparatus 10 comprises a track 14. The track 14 may comprise a metal, such as roll-formed steel, high strength steel, 14 gauge steel and the like. The track 14 may be roll formed in any desired length and cut as needed, i.e. to accommodate length of vehicle. General cross-sectional configuration of the track 14 is shown in FIGS. 2 and 3 where the track 14 is disposed adjacent a floor 16 of the vehicle.

Gauge of the material comprising the track 14 may match gauge of material comprising the floor 16 of the vehicle. With both the track 14 and the floor 16 being identical in thickness, assembly of the vehicle is facilitated by accommodating use of spot welding. The track 14 can be spot welded to the floor 16 at locations represented buy arrows in FIG. 3. Spot welding, at times using a robot, can be automated thereby encouraging consistent, repeatable and properly spaced welds between the track 14 and the floor 16.

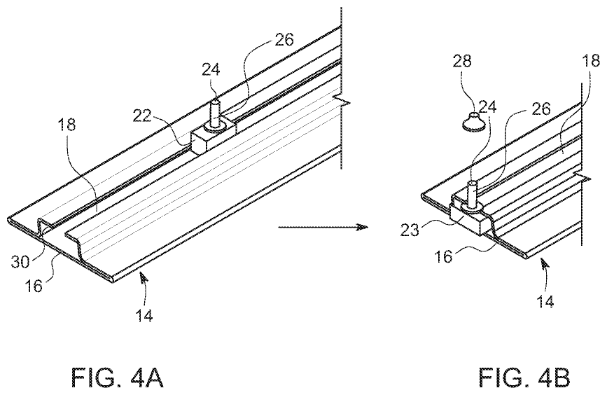

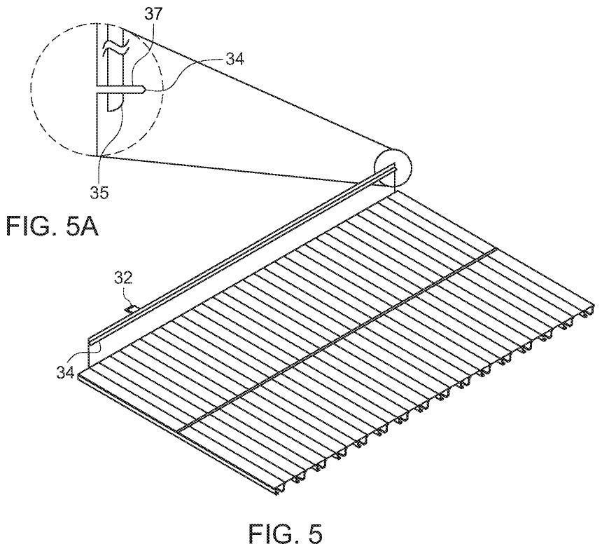

The track 14 comprises a groove 18 disposed along a length, i.e. longitudinally, of the track 14 as shown in FIG. 4 and FIG. 4A. The groove 18 accepts a portion of a stud 20. The stud 20 comprises a base 22 and a shank 24 extending from the base 22. In some embodiments, the shank 24 includes a shank aperture, such as a slot, a multi-lobular recess and the like, to accept a driver to transfer force to the stud 20. In sonic embodiments, the shank 24 includes a thread 26. The thread 26 can accept a fastener 28, such as a nut an the like. The base 22 is configured to allow the base 22 to be inserted into the groove 18 in the track 14. The base 22 and thereby the stud 20 can move longitudinally along groove 18 in the track 14. The base 22 includes a cam, not shown for clarity, that limits axial movement of the stud 20 due to interference between the cam and an inner surface 30 of the groove 18. For instance, when the fastener 28 is advanced along the thread 28 on the shank 24 of the stud 20 towards the base 22 of the stud 20, such as during mounting of a seat 12 in a vehicle, the cam engages the inner surface 30 of the groove 18 thereby limiting further axial movement of the stud 20 and retaining the stud 20 in position along the groove 18.

The apparatus 10 includes a flange 32, shown in FIGS. 5 and 5A, disposed adjacent a side wall of the vehicle. In some embodiments, the flange 32 comprises a portion of a side wall of a vehicle. The flange 32 includes a lip 34 extending substantially perpendicularly from one end of the flange 32. At least one lip aperture is formed in the lip 34. The at least one lip aperture can accept a lip fastener 35, such as a bolt and the like. The at lest one lip aperture may be reproduced to accommodate seats 12 to be mounted in a vehicle. The lip fastener 35 accepted by the at least one lip aperture connects an end of the seat 12 to the flange 32, as shown in FIG. 6.

A support 36, comprising at least one riser 38 and a base 40, is disposed at an end of the seat 12 opposite to an end of the seat 12 adjacent the lip 34. The base 40 includes a base aperture 42 that accepts an end of the shank 24 on the stud 20. Because the stud 20 can move along the groove 18 in the track 14, the seat 12 can be mounted to the track 14, and thus to the floor 16, at any location along a length of the track 14. Ability to move the stud 20 along the track 14 allows accommodation of any position of the at least one lip aperture in the lip 34 of the flange 32.

With embodiments of structures for mounting a seat 12 in a vehicle being discussed, now embodiments methods of mounting a seat 12 in a vehicle will be discussed.

According to one embodiment, a floor 16 is installed on a frame that will become a vehicle. At least one side wall is added to the frame. A track 14 having a groove 18 is attached to the floor 16. The attachment of the track 14 to the floor 16 may be may be accomplished by any suitable means, such as spot welding and the like. A stud 20 comprising a base 22 and a shank 24 is added to the groove 18. More specifically, the base 22 of the stud 20 is disposed within the groove 18. A flange 32 including a lip 34 and at least one lip aperture is attached to the side wall. A lip fastener 35 is accepted by the at least one lip aperture

A support 36 is disposed on an end of the seat 12. The support 36 comprises a riser 38 and a base 40. The base 40 includes a base aperture 42 that accepts a shank 24 comprising the stud 20. The seat 12 is positioned with respect to the at least one lip aperture on the lip 34 included on the flange 32. A fastener joining an end of the seat 12 opposite to the end thereof including the support 36 to the flange 32 is inserted into the at least one lip aperture on the lip 34 of the flange 32. The base 22 on the stud 20 is moved within the groove 18 on the track 14 to align the shank 24 on the stud 20 with the base aperture 42 on the base 40. A fastener 28 is applied to the thread 26 on the shank 24 of the stud 20.

It is to be recognized that embodiments disclosed herein can be employed to mount an item other than a seat, such as a crash barrier, a modesty panel and the like, to vehicle. Employing these embodiments may make vehicle assembly more economical and having reduced complexity.

1. An apparatus for mounting a seat in a vehicle having a floor and a side wall, the apparatus comprising:
a track having a groove disposed on the floor;
a stud including a base and a shank, the base being configured to be inserted into the groove;
a flange having a lip disposed on the side wall of the vehicle;
at least one lip aperture formed on the lip;
a support, including a base, disposed on one end of the seat;
a base aperture disposed on the base;
a lip fastener accepted by the at least one lip aperture to connect an end of the seat opposite to the base to the lip on the flange, the base aperture accepting the shank included on the stud.

2. The apparatus of claim 1 wherein the track comprises a metal.

3. The apparatus of claim 1 wherein the metal comprises steel.

4. The apparatus of claim 1 wherein material comprising the floor has a gauge equal to a gauge of material comprising the track.

5. The apparatus of claim 1 wherein the track is spot welded to the floor.
